(19) United States
(12) Patent Application Publication
(10) Pub. No.: US 2006/0265212 A1
(43) Pub. Date: Nov. 23, 2006

(54) Method for cell scheduling in a communication network

(75) Inventor: Laurence A. Fitzgerald, Dublin (IE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,678

(22) PCT Filed: Aug. 26, 2004
(86) PCT No.: PCT/IB04/02809

§ 371 Date: Feb. 27, 2006

(30) Foreign Application Priority Data
Sep. 2, 2003 (GB) 0320506.9

(51) Int. Cl. G10L 19/14

(52) U.S. Cl. 704/211

(57) ABSTRACT

A server has a Guaranteed-Bandwidth (GB) Array 21 and an Extra-Bandwidth (EB) Array 31 with differing Quality of Service requirements for transmission of cells held in queues. The server operating to distribute queues around a circular array until there is, at most, one queue per array location in order to minimise cell delay variation.

### TECHNICAL FIELD OF THE INVENTION

The present invention relates to methods for scheduling the transmission of cells in servers, to software for the scheduling of such cells and to servers.

### BACKGROUND ART

Traffic managers in internet routers utilise servers to schedule the transmission of cells in order to ensure cells waiting for transmission are sent out within a required time period to guarantee a certain level of service.

A table-based timing wheel may be used for scheduling events by positioning events at various locations in the table (namely at slots in the timing wheel) thereby to define the table of events, enabling reduction or elimination of searching.

The schedule can be pre-calculated off-line, and this is referred to as a static schedule. A dynamic schedule can be achieved by adding one or more events to the timing wheel at appropriate future locations, after a particular event occurs as described in “MDCSIM: A Compiled Event-Drive Multidelay Simulator” by Yun-Sik Lee, Peter M Maurer, Department of Computer Science and Engineering, University of South Florida, Tampa, Fla. 33620, U.S.A.

Guaranteed Bandwidth servers serve queues at a constant bit-rate, transferring the queues' packets to a link for onward transmission. Due to the random arrival pattern of packets at the tails of the queues, there are instants when the aggregate bandwidth at which Guaranteed Bandwidth servers serve their queues can be less than the link bandwidth. This allows Extra Bandwidth Servers to serve their queues on an opportunistic basis.

Various combinations of Guaranteed Bandwidth servers and Extra Bandwidth servers serving queues allow one to offer different classes of service to different flows of packets, for example:

Queues served by Guaranteed Bandwidth Servers only are used for constant bit-flows, or aggregates thereof, whose arrival pattern is regular, for example videoconferencing traffic:

Queues served by Extra Bandwidth Servers only are used for unspecified bit-rate flows and bandwidth flows, i.e. those whose arrival pattern are random. A good example is present-day Internet traffic:

Queues served by a combination of Guaranteed Bandwidth Server and Extra Bandwidth Server are used for variable bit-rate flows, the arrival pattern of which is a combination of regular and random traffic. An example would be some types of compressed video traffic, which can benefit from extra bandwidth when it is available.

Some examples of Guaranteed Bandwidth servers and Extra Bandwidth servers are described in “Providing QoS Guarantees in Packet Switches”, Fabio M. Chiussi and Andrea Francini, Proc. IEEE GLOBECOM'99. Seamless Interconnection for Universal Services. Symposium on High Speed Networks, volume V02, pages 1582-1590, Rio de Janeiro, Brazil, December 1999.

U.S. Pat. No. 5,696,764 describes a system having a Guaranteed Bandwidth array and an Extra Bandwidth array, which has a static schedule.

### OBJECTS OF INVENTION

An object of the present invention may be to provide a server, which provides more efficient transmission of cells.

Another object of the present invention may be to provide a more efficient data structure to enhance the transmission of cells.

Another object of the present invention is to provide a server, which is capable of handling variable bit rate traffic.

Another object of the present invention is to provide a server enabling the addition of one or more events to a timing wheel at appropriate future locations.

### SUMMARY OF INVENTION

The present invention provides a method of operating a server comprising two arrays of cells for transmission, being a Guaranteed-Bandwidth array and an Extra-Bandwidth array, the method comprising monitoring the Guaranteed-Bandwidth array for a cell which is ready for transmission, scheduling events corresponding to cells ready for transmission, and adding a single queue descriptor at an arbitrary location to the schedule so produced.

Preferably, in the method, each location points at a linked list of queues, and it comprises adjusting positioning of queue descriptors so that queues are served at appropriate times.

The method may utilise a timing wheel to effect the scheduling operation, advantageously with a three-dimensional timing wheel data structure. One or more events may be added to a timing wheel at appropriate future locations after a particular event occurs to effect dynamic scheduling.

The method may comprise optimising the spread of queue references in a list of the Guaranteed-Bandwidth array until there is one queue referenced per list entry.

Advantageously, the method comprises operating a circular buffer to effect the Guaranteed-Bandwidth array whereby, for a timeslot, a cell from a queue is pointed to an indexed position in the array, and/or operating a Guaranteed-Bandwidth array in an arrangement with several queues referenced by one list entry, serving a first queue at an indexed location and moving the pointer an amount corresponding to a service interval along the list.

The present invention may be implemented in hardware, for example in digital computers including network processors, and/or in software.

The present invention also provides a computer program product directly loadable into the internal memory of a digital computer, comprising software code portions for performing the method of monitoring the Guaranteed-Bandwidth array for a cell which is ready for transmission, scheduling events corresponding to cells ready for transmission, and adding a single queue descriptor at an arbitrary location to the schedule so produced.

The present invention also provides a computer program and a carrier embodying the present invention, and electronic distribution of the product, program and/or carrier.

The present invention also provides a server comprising two arrays of cells for transmission, being a Guaranteed-Bandwidth array and an Extra-Bandwidth array, the server comprising means to monitor the Guaranteed-Bandwidth array for a cell which is ready for transmission, means to schedule events corresponding to cells ready for transmission, and means to add a single queue descriptor at an arbitrary location to the schedule so produced.

The present invention is applicable to all forms of servers, especially routers and traffic managers.

### BRIEF DESCRIPTION OF THE DRAWINGS

In order that the present invention may more readily be understood, a description is now given, by way of example only, reference being made to the accompanying drawings in which:

FIG. 1 is a diagram of a Strict Priority Server for Guaranteed Bandwidth Servers and Extra Bandwidth Servers, as known from the prior art;

FIG. 2 is a diagram showing a Guaranteed Bandwidth List, embodying features of the present invention;

FIG. 3 is a diagram showing an Extra Bandwidth List, embodying features of the present invention;

FIG. 4 is a diagram showing an ensemble of a Guaranteed Bandwidth List and an Extra Bandwidth List, embodying features of the present invention; and

FIGS. 5 and 6 show cell structures for serving according to the present invention.

### SPECIFIC DESCRIPTION OF THE EMBODIMENTS

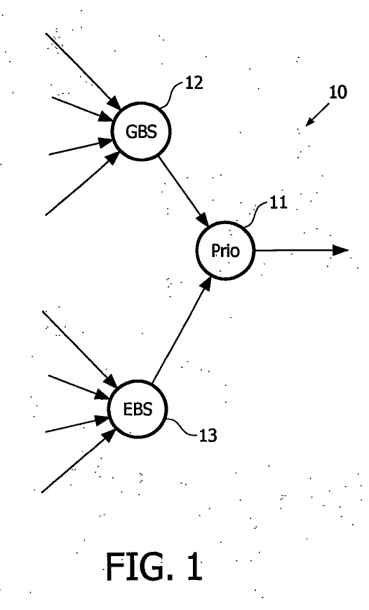

FIG. 1 represents the nodes of a scheduler 10 as known from the prior art, which may be based, for example, on a Strict Priority Server 11 as shown here. The Strict Priority Server 11 is served by a Guaranteed Bandwidth Server 12 and an Extra Bandwidth Server 13.

The network elements of current packet-switched networks generally segment the variable-length packets that arrive at the node into fixed-length cells, so that the transport of said cells can be managed uniformly within the node. The fixed length of the cells makes the memory management of the data buffers in which the cells are stored feasible. To provide a particular Quality of Service, an ability to transmit certain cells more quickly than others is required, which is only possible by delaying some cells. In order to provide different delays to different flows of cells awaiting service by a scheduler, the cells may be placed in a plurality of queues.

In a conventional system, the scheduling of the transmission of the cells typically involves either the insertion of a pointer to a queue into a heap, or the searching of a list of queues in order to find a cell ready for transmission. Both arrangements are very inefficient methods.

The present invention is distinguished over the prior art by providing both a novel data structure and a novel search algorithm.

The data structure and the search algorithm function collectively, after repeated application of the algorithm, to encourage the distribution of the queues around a circular array until there is, at most, one queue per array location.

As a result of this, cell delay variation will be minimised, while the problem of searching for a suitable cell to transmit during a particular time-slot is reduced to incrementing a pointer. This process assures a high level of scheduling accuracy, while providing a very fast scheduling mechanism involving no extensive searches.

A system according to the invention may appear, prima facie, to be unreliable in that both the order of transmission of cells is initially assigned arbitrarily, and the scheduling appears to result in multiple cells being scheduled for transmission simultaneously.

However, the method employed to distribute queues around the array ensures that a constant bandwidth can be allocated to any queue requiring one as such, while by repeated application of an algorithm, an optimal order of transmission is arrived at.

Hence, the problem presented by the prior art of searching lists, heaps or stacks, for example, is not solved but rather bypassed.

The data structure provided by the present invention comprises an ensemble of a Guaranteed Bandwidth List and an Extra Bandwidth List.

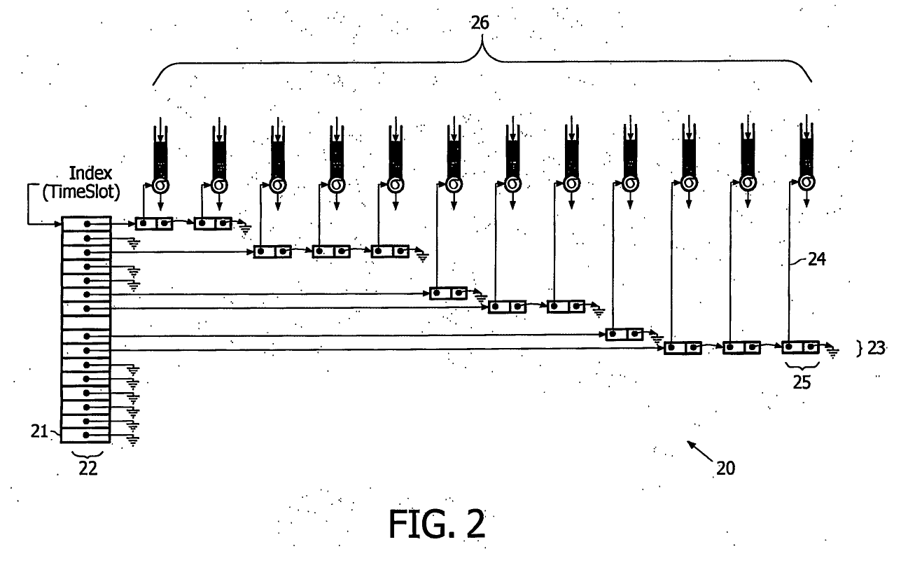

FIG. 2 represents the structure of a Guaranteed Bandwidth List 20 in accordance with the present invention. The Guaranteed Bandwidth List 20 comprises a time-ordered array of pointers 22 to linked-lists 23, the Guaranteed Bandwidth Array 21, shown at the bottom of FIG. 2. The data pointers 24 in each of the nodes 25 of the linked-lists point to queues 26 of cells waiting to be served, for example the queues designated as GB (Guaranteed Bandwidth), or AF (Assured Forwarding). The pointers 22 are ordered by the time of arrival at the router.

The queues 26 have various Quality of Service requirements, which in the Guaranteed Bandwidth Array might be GB (Guaranteed Bandwidth) queues or AF (Assured Forwarding) queues.

The data structure associated with each queue 26 contains a parameter, the service interval, indicating the time interval over which that queue 26 should be served, i.e. the number of time-slots that should elapse before the next cell of that queue 26 is scheduled for transmission. Note that one cell is transmitted per time-slot.

Each queue 26, in the linked-lists 23 at each array location, is visited in turn, so that a cell from each queue 26 is transmitted within a guaranteed time of the transmission of the previous cell from the same queue 26, provided a cell is available for transmission. Of course, the queue may be, for example, empty.

Control software in the node element must ensure that the bandwidth occupied by the GB cells does not exceed the bandwidth of the link. The Traffic Manager, by configuration, ensures that the number of GB cells is less than the number of available timeslots.

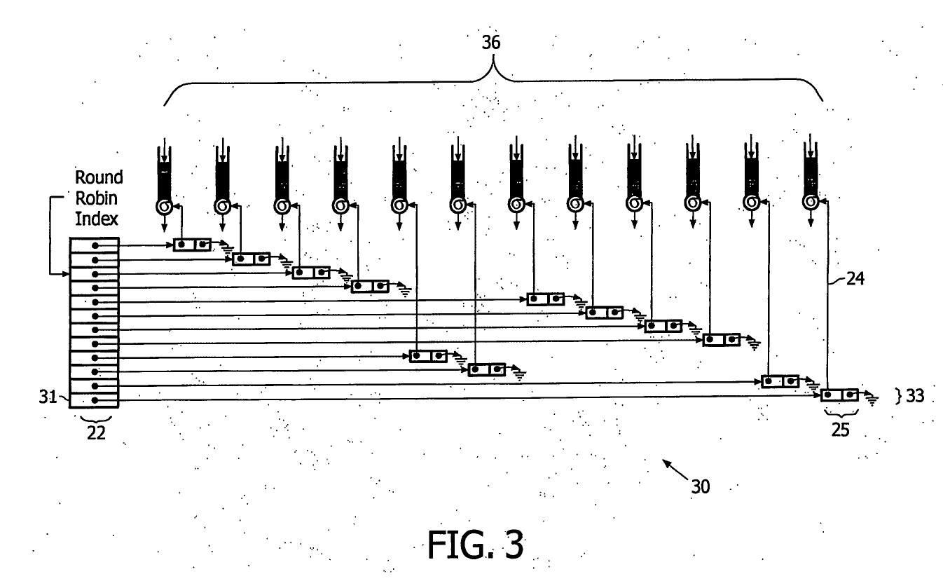

FIG. 3 represents the structure of an Extra Bandwidth List 30 in accordance with the present invention. Where a feature is retained from FIG. 2, the same numeral has been used.

The Extra Bandwidth List 30 comprises an array, the Extra Bandwidth Array 31, of pointers 22 to linked-lists 33. The data pointers 24 in each of the nodes 25 of the linked-lists 33 point to queues 36 of cells waiting to be served. This array 31 is not time-ordered.

The queues 36 of the Extra Bandwidth Array 31 differ from the queues 26 of the Guaranteed Bandwidth Array in their Quality of Service requirements, in that queues 26 of the GB Array 21 are GB or AF queues, whereas the queues 36 of the Extra Bandwidth Array 31 are AF or BE (Best Effort) queues.

Additionally, the linked-lists 33 of the Extra Bandwidth Array contain only one node 25, and therefore one queue to be served.

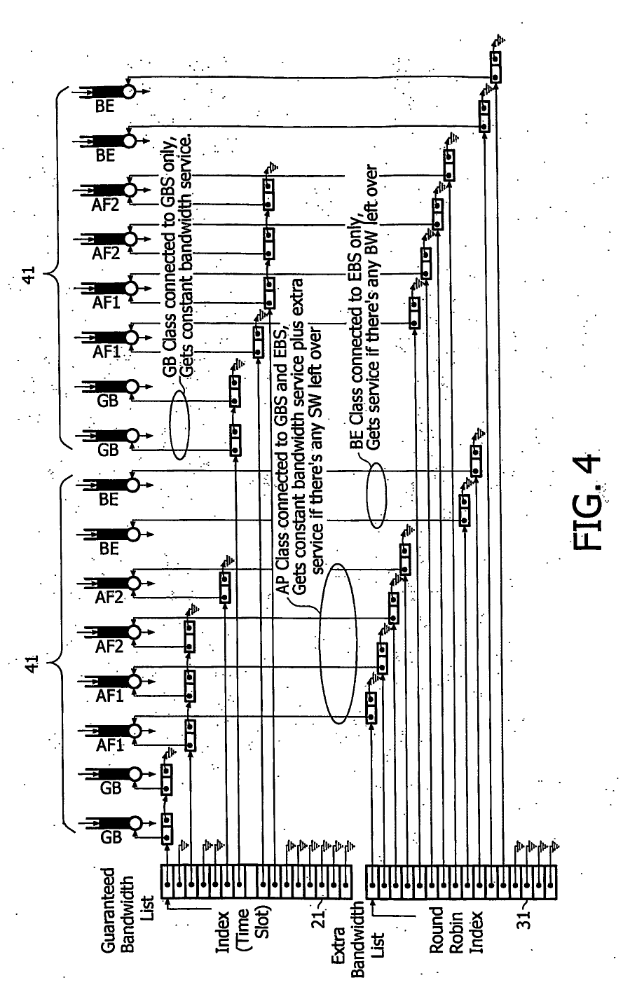

FIG. 4 represents an ensemble 40 of a Guaranteed Bandwidth List 21 and an Extra Bandwidth List 31, with queues 41.

In the ensemble, the pointers in the GB Array 21 point to GB and AF queues, while those in the EB Array 31 point to AF and BE queues. The GB queues are guaranteed timeslots at regular intervals, whereas the AF queues are allocated a constant bandwidth through the GB Array 21, plus any extra service where bandwidth is available through the EB Array 31.

As mentioned hereinbefore, the present invention is distinguished over the prior art by providing, in addition to the data structure, a novel search algorithm.

For the purposes of the search algorithm, three counter/pointers are defined:

RealTimeCounter;

TimeSlotIndex;

RoundRobinIndex.

RealTimeCounter is incremented (modulo Guaranteed Bandwidth ArrayLength) once each cell arrival period. RealTimeCounter effectively keeps track of real time, by counting the number of elapsed timeslots.

Due to the modulo arithmetic, when the end of the GB Array is reached, Real Time Counter returns back to the start. ArrayLength is calculated from the ratio of the aggregate bandwidth at which all flows of cells are served, to the lowest bandwidth at which any one flow of cells is served.

As the cells arrive over a connection, which carries a fixed number of bits per second, and the cells have a fixed length, the cell arrival rate will be constant. The inverse of this cell arrival rate is the cell arrival period.

TimeSlotIndex indicates the linked-list 23 of queues to be searched by the GB Server. Unlike the EB Array, there can be more than one queue in such a list. TimeSlotIndex is incremented (modulo Guaranteed Bandwidth ArrayLength) as described hereinafter.

RoundRobinIndex points to the next queue to be served by the Extra Bandwidth Server 13, and is incremented each time the Extra Bandwidth Server 13 removes a cell from the queue.

The priority scheduler 11 is connected to a Guaranteed Bandwidth Server 12, which serves a number of queues, and also connected to an Extra Bandwidth Server 13, which may be invoked if the Guaranteed Bandwidth Server 12 does not have a cell ready to send.

A search is instigated once per timeslot (cell arrival period). In each timeslot, the Guaranteed Bandwidth Server 12 is invoked first.

The flow of execution for one timeslot is as follows:
1) increment the RealTimeCounter (modulo Guaranteed Bandwidth ArrayLength);
2) the Guaranteed Bandwidth Server is invoked, with the current TimeSlotIndex as a parameter. The Guaranteed Bandwidth Server carries out a search of the list of queues pointed to by the pointer at the current GB Array 21 location, and continues, incrementing the TimeSlotIndex (every time the end of a list, or an empty list, is found): until a cell is found; or
   until the lists at two successive array locations have been searched; or until the TimeSlotIndex equals the RealTimeCounter value (i.e., any spare slots not taken by GB cells have been occupied by EB cells). If the ends (indicated by a null pointer) of two successive lists are reached, an EB cell, if one exists, is then sent. TimeSlotIndex is then incremented, to prevent the second empty list being searched again at the start of the next timeslot.
3) if a cell was found:
   then the Guaranteed Bandwidth pointer position is stored, the cell is retrieved and sent. The priority scheduler is now completed for this timeslot.
   An element of the Guaranteed Bandwidth Array 21 points to a linked-list 23 of nodes 25, the data pointer 24 of which in each case points to an output queue 41. The linked-list node 25 pointing at the most recently served queue 41 is removed from the linked-list 23 and inserted in a list further along the Guaranteed Bandwidth Array 21. The position of this new list 23 is calculated as the sum of the RealTimeCounter value and the service interval, stored in the data structure associated with that queue 41, indicating the time interval (i.e. the number of timeslots into the future) over which that queue 41 should be served.
   For an ensemble of queues of cells waiting to be transmitted over a link that operates at a fixed rate, the fixed rate must be greater than, or equal to, the sum of the rates at which each individual queue is served. For each individual such queue, the interval over which that queue should be served, i.e. the service interval, is the reciprocal of the cell transmission rate.
   The difference between the indices of the two array elements belonging to the queue, as served and as rescheduled, corresponds to the inverse of the rate at which the queue in question should be served.
   In this way, each queue in the GB List can be supplied at a guaranteed bandwidth.
   The variations in service intervals of the queues will determine how the linked-lists are dynamically constructed. For instance, if a pointer is inserted into an empty list, the node attached thereto will be searched first when TimeSlotIndex reaches this list. Or, if that list already contains a pointer to a node, the added node will be linked onto the existing node.
   As the value of TimeSlotIndex is stored, the GB Server will return to the same array location in the next iteration to search for another cell ready to transmit. Providing another queue from the same list is then served, due to RealTimeCounter being incremented by one, while the service interval for the two queues remains identical, this next queue will be rescheduled for service at the succeeding array location, thereby distributing the queues from being concentrated at one location to being spread around the array.
4) if a cell was not found:
   the Extra Bandwidth Array 31 is searched, starting from the current position in the Extra Bandwidth Array 31.
      1) if a cell was found, then the position in the Extra Bandwidth Array 31 is stored, and the cell is retrieved and sent. The priority scheduler is now completed for this timeslot.
      2) if a cell was not found, the priority scheduler sends an idle cell and completes.

The Guaranteed Bandwidth Array 21 can be thought of as a circular array of lists of queues to be served, with two pointers, RealTimeCounter and TimeSlotIndex. RealTimeCounter is incremented once per cell transmission time.

When the end of the GB Array (a circular list) is reached, the operation will return to the start of the array.

In order to exemplify the above description, it can be assumed that RealTimeCounter and TimeSlotIndex both have the value ‘N’. The Nth element of the Guaranteed Bandwidth Array 21, GB Array[N], may point to a list of queues all waiting to be served at timeslot ‘N’. If there are, for example, three queues awaiting service at timeslot ‘N’, then the Nth element of the Guaranteed Bandwidth Array 21 points to a list of three queues which must be served one at a time over three successive timeslots.

Each of the three queues in the linked-list pointed to by the array location GB Array[N] should be served at a particular rate, the inverse of which is the service interval I. The first queue will be served at TimeSlot[N], the second at TimeSlot[N+1] and the third at TimeSlot[N+2]. The three queues will be scheduled to be next served at three different time-slots, TimeSlot[N+I], at TimeSlot[N+1+I] and TimeSlot[N+2+I] respectively, thereby causing the queues to be spread around the array rather than concentrated at one array location.

When the queues come to be served next the searching, and therefore computation, necessary to locate a cell ready for transmission is reduced.

No search is necessary; the search is eliminated, and thus also the computational overhead associated with a search. Other methods in the literature involve the idea of searching a structure for the most appropriate cell to transmit which involves a lot of computation.

After the three queues have been served, TimeSlotIndex will lag RealTimeCounter by three cell intervals. TimeSlotIndex must catch up with RealTimeCounter, in order to ensure that traffic is served at the advertised rate, by encountering a few successive elements of the Guaranteed Bandwidth Array 21 that point to empty lists.

TimeSlotIndex is restricted to incrementing twice per cell interval while empty lists are encountered, and if nothing in the Guaranteed Bandwidth Array 21 is found to transmit, then a search of the Extra Bandwidth Array 31 is invoked, i.e. termination of the search occurs when searching of two successive empty array locations arises.

In this way, a cell may be transmitted every cell interval without excessive searching of empty lists, and queues are served in real time.

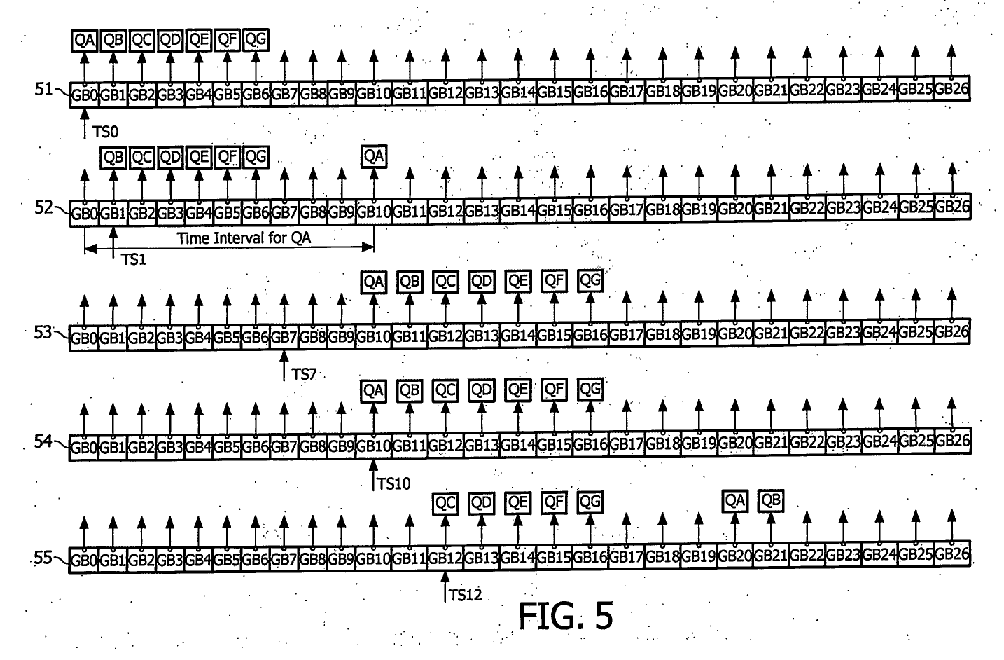

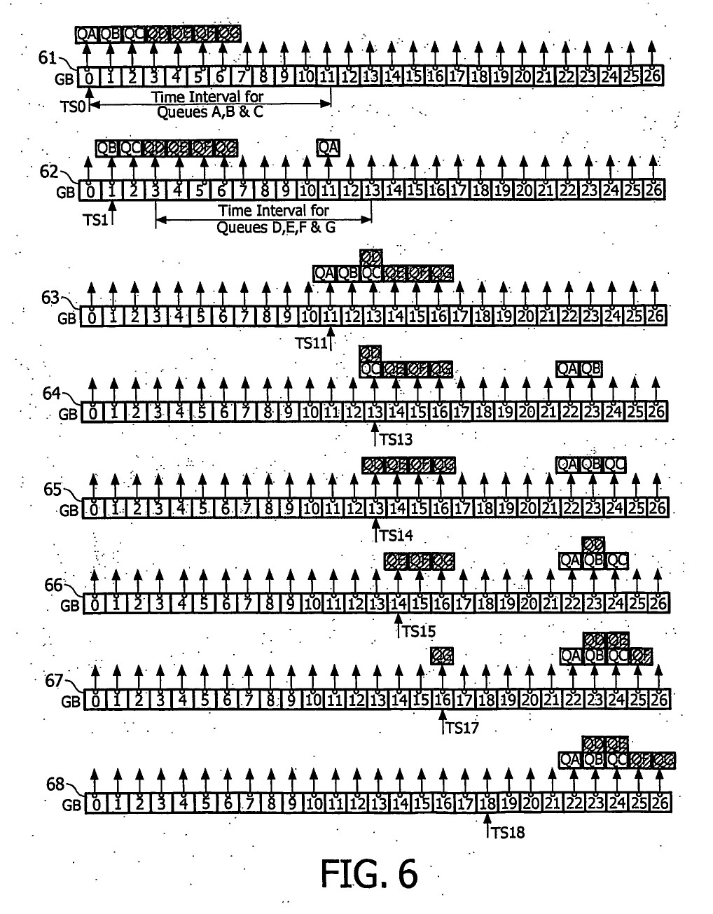

Each of FIGS. 5 and 6 represent five successive steps in an algorithm of the present invention operating on a sequence of 26 cells, whereby the cells are arranged for transmission.

In FIG. 5, diagram 51, the seven queues awaiting transmission each have identical Quality of Service requirements, with an identical service interval.

Initially, during the first time-slot, a cell from QA is transmitted, as shown in diagram 52. The pointer to QA is then moved to the location GB10 in the GB Array 21, this position being calculated as the sum of the RealTimeCounter value, which here is zero (incremented at the start of the time-slot to zero from the end of the GB Array, due to the modulo arithmetic), and the service interval for QA, which here is 10 slot intervals.

In the next time-slot, QB is then served and the pointer thereto relocated at position GB11 in the array, one position subsequent to QA as RealTimeCounter has incremented by one.

Henceforth, the remaining queues are served until all seven queues have been served and scheduled, as shown in diagram 53.

Empty locations in the GB Array, GB7 to GB9, will now be encountered, resulting in queues from the EB Array 31 being served in a round-robin fashion. As TimeSlotIndex is limited to searching two successive lists per slot interval, GB6 (the search begins from GB6 as the value of TimeSlotIndex was stored previously due to a cell being found) and GB7 will be searched before an EB queue is served. GB8 and GB9 will then be searched and another EB queue served. In the next slot interval, GB10 will be searched, whereupon a cell in QA at GB10 will be found and transmitted.

In diagrams 54 and 55, the queues will then be served and scheduled as before.

QA will be served again in the 10th time slot (when RealTimeCounter is 9), due to the two EB queues served, and scheduled for transmission again at GB20. The service interval for the queues here is 10 slot intervals 10+10=20. The placement of QA at BG20 is due to the service interval.

In FIG. 6, QA to QC have a different Quality of Service requirement to QD to QG: QA to QC have a service interval of 11 slot intervals; QD to QG have a service interval of 10 slot intervals.

In diagrams 61 and 62, the queues are served in a similar manner to those in diagrams 51 and 52. In diagram 63, however, the different service intervals of QC and QD have resulted in the two queues being scheduled for service in the same time-slot.

QC was initially served in the third time-slot, whereupon the pointer to QC was moved to a position calculated by the sum of the RealTimeCounter value, 2, and the service interval, 11, resulting in QC being located at GB13. QD was served in the fourth time-slot, and moved to a position calculated by the sum of the RealTimeCounter value, 3, and the service interval, 10, resulting in QD also being located at GB13.

Between the transmission of cells from queues QG and QA, two EB queues are served. The first during the next timeslot, when GB7 and GB8 won't be pointing at a queue, and a second during the timeslot after that.

When QC comes to be served again in the 12^{th} time-slot, when RealTimeCounter is 11, QC will then be scheduled at array location GB22, whereas in the 13^{th} time-slot, QD will be scheduled at GB22, thereby distributing the two queues along the array.

It will be apparent to a person skilled in the art that data structures or algorithms other than those described herein could be employed without departing from the scope of the invention as claimed.

For example, although the invention has been described herein as limiting a search of linked-lists to two empty locations, there exists a design choice between the number of linked-lists to be searched during one time-slot and the rate at which TimeSlotIndex will catch up with RealTimeCounter.

Each of FIGS. 5 and 6 represent 5 successive steps in an algorithm of the present invention operating on a sequence of 26 cells timeslots, whereby the cells are arranged for transmission.

FIG. 5 shows an initial association of queues with elements in the Guaranteed Bandwidth Array, during timeslot TSO. The time interval for all queues is 10. [52] shows the situation a timeslot later, (TS1) QA has had a cell dequeued for transmission, and has been moved to Guaranteed Bandwidth Array position 10. [53] show the situation at timeslot TS7. QB and QG have now had a cell dequeued for transmission, and QA and QG occupy Guaranteed Bandwidth Array positions 10 through 16. [53] show the situation at timeslot TS10. QA to QG still occupy Guaranteed Bandwidth Array positions 10 through 16. [55] shows the situation at timeslot TS12. The intention of FIG. 5 is to step through a scenario where all queues are served at equal rates (and hence have equal time intervals).

The intention of FIG. 6 is to step through a scenario where queues are served at different rates (and hence do not have equal time intervals). [63] shows the situation at TS11; note that Guaranteed Bandwidth array position 13 now points at a linked list with two elements' QD and QC. By TS 18, the Guaranteed Bandwidth Array again points at linked lists containing one element each; the distribution of queues across timeslots is again flat.

1. A method of operating a server comprising two arrays of cells for transmission, being a Guaranteed-Bandwidth array (12, 20, 21) and an Extra-Bandwidth array (13, 30, 31), the method comprising monitoring the Guaranteed-Bandwidth array for a cell which is ready for transmission, scheduling events corresponding to cells ready for transmission, and adding a single queue descriptor at an arbitrary location to the schedule so produced.

2. A method according to claim 1, wherein each location points at a linked list (23, 33) of queues (26, 36).

3. A method according to claim 1 comprising adjusting positioning of queue descriptors so that queues (26, 36) are served at appropriate times.

4. A method according to claim 1 comprising using a timing wheel to effect the scheduling operation.

5. A method according to claim 4, comprising a three-dimensional timing wheel data structure.

6. A method according to claim 1 comprising adding one or more events to a timing wheel at appropriate future locations after a particular event occurs to effect dynamic scheduling.

7. A method according to claim 1 comprising re-iterating recalculation of the schedule of events.

8. A method according to claim 1 comprising optimising the spread of queue references in a list of the Guaranteed-Bandwidth array (12, 20, 21) until there is one queue (26) referenced per list entry.

9. A method according to claim 1 comprising operating a circular buffer to effect the Guarantee-Bandwidth array (12, 20, 21) whereby, for a timeslot, a cell from a queue (26) is pointed to an indexed position in the array.

10. A method according to claim 1 comprising operating a Guaranteed-Bandwidth array (12, 20, 21) in an arrangement with several queues (26) referenced by one list entry (23), serving a first queue at an indexed location and moving the pointer an amount corresponding to a service interval along the list.

11. A method according to claim 1 comprising operating the Extra-Bandwidth array (13, 30, 31) only when no cell to be sent is found in the Guaranteed-Bandwidth array (12, 20, 21).

12. A computer program product directly loadable into the internal memory of a digital computer, comprising software code portions for performing the method of monitoring the Guaranteed-Bandwidth array (12, 20, 21) for a cell which is ready for transmission, scheduling events corresponding to cells ready for transmission, and adding a single queue descriptor at an arbitrary location to the schedule so produced.

13. A computer program product directly loadable into the internal memory of a digital computer, comprising software code portions for performing the method of claim 1 when said program is run on a computer.

14. A computer program directly loadable into the internal memory of a digital computer, comprising software code portions for performing the method of claim 1 when said program is run on a computer.

15. A carrier, which may comprise electronic signals, for a computer program of claim 14.

16. Electronic distribution of a computer program product of claim 12.

17. A server comprising two arrays of cells for transmission, being a Guaranteed-Bandwidth array (12, 20, 21) and an Extra-Bandwidth array (13, 30, 31), the server comprising means to monitor the Guaranteed-Bandwidth array for a cell which is ready for transmission, means to schedule events corresponding to cells ready for transmission, and means to add a single queue descriptor at an arbitrary location to the schedule so produced.

18. A server according to claim 17 comprising means to point each location at a linked list (23, 33) of queues (26, 36).

19. A server according to claim 17 comprising means to adjust positioning of queue descriptors so that queues (26, 36) are served at appropriate times.

20. A server according to claim 17 comprising a timing wheel to effect the scheduling operation.

21. A server according to claim 20, wherein the timing wheel comprises a three-dimensional timing wheel data structure.

22. A server according to claim 17 comprising means to add one or more events to a timing wheel at appropriate future locations after a particular event occurs to effect dynamic scheduling.

23. A server according to claim 17 comprising means to re-iterate recalculation of the schedule of events.

24. A method of operating a server substantially as hereinbefore described with reference to, and/or as illustrated in, any one or more of FIGS. 2 to 6 of the accompanying drawings.

25. A server substantially as hereinbefore described with reference to, and/or as illustrated in, any one or more of FIGS. 2 to 6 of the accompanying drawings.
